(19) United States
(12) Patent Application Publication
(10) Pub. No.: US 2020/0055880 A1
(43) Pub. Date: Feb. 20, 2020

(54) INHIBITED NOBLE METAL-FREE MIXTURE THAT CAN BE HYDROSILYLATED

(71) Applicant: WACKER CHEMIE AG, Munich (DE)

(72) Inventor: Elke Fritz-Langhals, Ottobrunn (DE)

(21) Appl. No.: 16/478,320

(22) PCT Filed: Oct. 10, 2017
(86) PCT No.: PCT/EP2017/075824

§ 371 Date: Jul. 16, 2019

(51) Int. Cl. C07F 7/08

(52) U.S. Cl. CPC C07F 7/0879

(57) ABSTRACT

The invention provides a mixture M containing
compound A which contains at least one hydrogen atom bound directly to Si,
compound B which contains at least one carbon-carbon multiple bond,
compound C which contains at least one cationic Si(II) group and
compound D which contains at least one alkoxy group bound directly to silicon,
and also a method for hydrosilylating the mixture M, wherein the mixture M is heated.

The invention relates to a hydrosilylatable mixture which contains a compound having a cationic Si(II) group as catalyst and a method for hydrosilylating the mixture by heating.

The addition of hydrosilicon compounds onto alkenes and alkynes plays an important role in industry. This reaction, which is referred to as hydrosilylation, is very frequently used for crosslinking siloxanes (elastomer crosslinking) or for introducing functional groups into silanes or siloxanes. The hydrosilylations are generally carried out industrially using noble metal complexes in combination with inhibitors, frequently based on alkynes, which block the hydrosilylation at ambient temperatures. This makes it possible to mix the components including the catalyst homogeneously without, hydrosilylation commencing. The hydrosilylation process can then be treated by increasing the temperature. A further advantage is that mixing takes place at a different time from the hydrosilylation process and can be controlled in a targeted manner; one-component systems can be reacted solely by increasing the temperature.

A disadvantage of the noble metal-catalyzed hydrosilylation is the high price of the noble metals which have only limited availability worldwide and are subject to unforeseeable and uninfluenceable price fluctuations. In addition, it is frequently not possible or not economical to recover the noble metals. A hydrosilylation catalyst which is free of noble metal is therefore of great industrial interest.

Recently, Chirik et al. in Science 2012, 335, 567, ACS Catalysis 2016, 6, 2632 and ACS Catalysis 2016, 6, 4105, for example, have proposed transition metal complexes, especially of iron, cobalt and nickel as alternatives, but these display unsatisfactory stability, so that it is necessary to use relatively large amounts, which frequently leads to discoloration. However, an even more serious disadvantage of these systems is that up to the present time there are no inhibited systems which make it possible to suppress the hydrosilylation during the mixing operation and start it in a targeted manner by increasing the temperature.

It is therefore an object of the present invention to provide a noble metal-free hydrosilylatable mixture which is stable at ambient temperature over a prolonged period of time and the reaction of which can be triggered by increasing the temperature.

The invention provides a mixture M containing

compound A which contains at least one hydrogen atom bound directly to Si,
compound B which contains at least one carbon-carbon multiple bond,
compound C which contains at least one cationic Si(II) group and
compound D which contains at least one alkoxy group bound directly to silicon.

It has surprisingly been able to be shown that the hydrosilylation reaction catalyzed by compound C as nonmetallic hydrosilylation catalyst can be completely suppressed by the addition of alkoxysilicon compounds D, especially at ambient temperature, and be triggered by increasing the temperature. Alkoxysilicon compound D can thus be used as inhibitor for the hydrosilylation reaction with the nonmetallic hydrosilylation catalyst C.

The compound A having at least one hydrogen atom bound directly to Si preferably has the general formula I

R¹R²R³Si—H (I),

where the radicals R¹, R² and R³ are each, independently of one another, hydrogen, halogen, a silyloxy radical or a hydrocarbon radical, in which individual carbon atoms can in each case be replaced by oxygen atoms, silicon atoms, nitrogen atoms, halogen, sulfur or phosphorus atoms.

The radicals R¹, R² and R³ are each, independently of one another, particularly preferably hydrogen, halogen, an unbranched, branched, linear, acyclic or cyclic, saturated or monounsaturated or polyunsaturated C1-C20-hydrocarbon radical, in which individual carbon atoms can be replaced by oxygen, halogen, nitrogen or sulfur, or a silyloxy radical of the general formula II

(SiO_{4/2})ₐ(R^{x}SiO_{3/2})_{b}(R^{x}₂SiO_{2/2})_{c}(R^{x}₃SiO_{1/2})_{d}— (II)

where
the radicals R^{x} are each, independently of one another, hydrogen, halogen, an unbranched, branched, linear, acyclic or cyclic, saturated or monounsaturated or polyunsaturated C1-C20-hydrocarbon radical, in which individual carbon atoms can be replaced by oxygen, halogen, nitrogen or sulfur,
a, b, c and d are, independently of one another, integers from 0 to 100 000, where the sum of a, b, c and d together is at least 1.

The radicals R¹, R² and R³ are each, independently of one another, very particularly preferably hydrogen, chlorine, a C1-C3-alkyl or alkylene radical, a phenyl radical or a silyloxy radical of the general formula II in which the radicals R^{x} are each, independently of one another, hydrogen, chlorine, C1-C6-alkyl or alkylene or phenyl.

Particularly preferred radicals R¹, R² and R³ are the radicals methyl, ethyl, propyl, phenyl, chlorine or a silyloxy radical, in particular of the general formula II.

Particularly preferred radicals R^{x} are the radicals methyl, ethyl, propyl, phenyl and chlorine.

Examples of compounds A of the general formula (I) are the following silanes (Ph=phenyl, Me=methyl, Et=ethyl):

Me₃SiH, Et₃SiH, Me₂PhSiH, MePh₂SiH, Me₂ClSiH, Et₂ClSiH, MeCl₂SiH, Cl₃SiH, and the following siloxanes:
H—SiMe₂-O—SiMe₂H, Me₃Si—O—SiHMe-O—SiMe₃,
H—SiMe₂-(O—SiMe₂)ₙ—O—SiMe₂-H where m=1 to 20 000,
Me₃Si—O—(SiMe₂-O)ₙ(SiHMe-O)ₒ—SiMe₃ where n=1 to 20 000 and o=1 to 20 000.

The compound A can also be a mixture of various compounds, in particular of the general formula I, in which the radicals R¹, R² and R³ can optionally be various radicals of the general formula II.

The compounds B having at least one carbon-carbon multiple bond are preferably selected from among compounds having at least one carbon-carbon double bond of the general formula IIIa

R⁴R⁵C═CR⁶R⁷ (IIIa),

and compounds having at least one carbon-carbon triple bond of the general formula IIIb

R⁸CCR⁹ (IIIb),

where
R⁴, R⁵, R⁶, R⁷, R⁸ and R⁹ are each, independently of one another, a linear, branched, acyclic or cyclic, saturated or monounsaturated or polyunsaturated C1-C20-hydrocarbon radical, in which individual carbon atoms can be replaced by silicon, oxygen, halogen, nitrogen, sulfur or phosphorus.

Mixtures of the compounds of the general formula IIIa and IIIb can also be present.

The radicals R⁴, R⁵, R⁶, R⁷, R⁸ and R⁹ are each, independently of one another, particularly preferably hydrogen, a linear, branched, acyclic or cyclic, saturated or monounsaturated or polyunsaturated C1-C20-hydrocarbon radical which can be substituted by one or more heteroatom groups, in particular the groups halogen, in particular chlorine, nitrile, alkoxy, COOR^{z}, O—CO—R^{z}, NH—CO—R^{z}, O—CO—OR^{z}, where the radicals R^{z} are each, independently of one another, hydrogen, chlorine, C1-C6-alkyl or alkylene or phenyl.

Particular preference is given to one or more of the radicals R⁴ to R⁹ being hydrogen.

Very particular preference is given to R⁴ and R⁵ or R⁶ and R⁷ being hydrogen.

Examples of compounds B are ethylene, propylene, 1-butylene, 2-butylene, cyclohexene,

styrene, α-methylstyrene, 1,1-diphenylethylene, cis-stilbene, trans-stilbene,
allyl chloride, acrylonitrile, allyl glycidyl ether, vinyl-SiMe₂-[O—SiMe₂]ₙ—SiMe₂-vinyl where n=0 to 10 000, Me₃Si—[O—SiMevinyl]ₒ-[O—SiMe₂]ₚ—SiMe₃ where o=1 to 1000 and p=0 to 1000, acetylene, propyne, 1-butyne, 2-butyne, phenylacetylene and diphenylacetylene.

The compounds A and B can also be joined to one another by one or more chemical bonds, i.e. they can both be present in one molecule.

The compound C contains one or more cationic Si(II) groups.

The compound C is preferably a cationic Si(II) compound of the general formula IV

([Si(II)Cp]⁺)ₐX^{a-} (IV)

where
Cp is a π-bonded cyclopentadienyl radical of the general formula V, which is substituted by the radicals R^{y}.

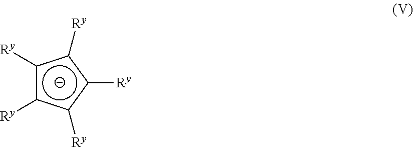

For the purposes of the present invention, the cyclopentadienyl radical Cp is the cyclopentadienyl anion which consists of a singly negatively charged, aromatic five-ring system C₅R^{y}₅_{⁺}. The radicals R^{y} are any monovalent radicals or polyvalent radicals, which can also be joined to one another to form fused rings.

The radicals R^{y} are each, independently of one another, preferably hydrogen, linear or branched, acyclic or cyclic, saturated or monounsaturated or polyunsaturated C1-C20-alkyl or aryl radicals, particularly preferably C1-C3-alkyl radicals, very particularly preferably methyl, radicals.

Examples of radicals R^{y} are alkyl radicals such as the methyl, ethyl, n-propyl, isopropyl, n-butyl, sec-butyl, isobutyl, tert-butyl, n-pentyl, sec-pentyl, isopentyl, neopentyl, tert-pentyl radical; hexyl radicals such as the n-hexyl radical; heptyl radicals, such as the n-heptyl radical; octyl radicals such as the n-octyl radical and isooctyl radicals, such as the 2,4,4-trimethylpentyl radical; nonyl radicals such as n-nonyl radical; decyl radicals, such as the n-decyl radical; dodecyl radicals such as the n-dodecyl radical; hexadecyl radicals such as the n-hexadecyl radical; octadecyl radicals such as the n-octadecyl radical; cycloalkyl radicals such as the cyclopentyl, cyclohexyl, cycloheptyl radical and methyleyelohexyl radical; aryl radicals such as the phenyl, naphthyl, anthryl and phenanthryl radical; alkaryl radicals such as the o-, m- and p-tolyl, xylyl, mesitylenyl and o-, m- and p-ethylphenyl radical; and alkaryl radicals such as the benzyl radical, the α- and β-phenylethyl radical.

Further examples of compounds C are the following cationic Si(II) compounds:

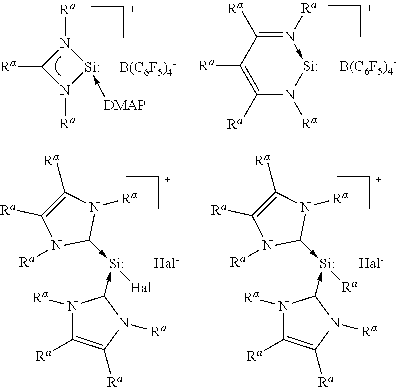

the preparation of which is described in So et al, Chem. Eur. J. 2013, 19, 11786, Driess et al., Angew. Chem. Int. Ed. 2006, 45, 6730, Filippou, Angew. Chem. Int. Ed. 2013, 52, 6974, Sasamori et al, Chem. Eur. J. 2014, 20, 3246 and in Inoue et al., Chem. Commun. 2014, 50, 12619 (DMAP=dimethylaminopyridine). In the above formulae, the radicals R^{a} are hydrocarbon radicals. The radicals R^{a} are each, independently of one another, preferably an alkyl radical, in particular C1-C20-alkyl radical, or a substituted or unsubstituted phenyl radical, particularly preferably a branched alkyl radical or a 2,6-dialkylated phenyl radical. Hal is halogen, preferably chlorine, bromine or iodine. Examples of radicals R^{a} are methyl, isopropyl, tert-butyl, 2,6-diisopropylphenyl or 2,4,6-triisopropylphenyl.

X^{a-} is any a-valent anion which does not react with the cationic silicon(II) center under the reaction conditions of a hydrosilylation. It can be either inorganic or organic. a is preferably 1, 2 or 3, in particular 1.

X⁻¹ is particularly preferably halogen or a complex anion such as BF₄⁻, ClO₄⁻, AlZ₄⁻, MF₆⁻ where Z=halogen and M=P, As or Sb or a tetraarylborate anion, where the aryl radical is preferably phenyl or fluorinated phenyl or phenyl substituted by perfluoroalkyl radicals, a monovalent polyhedral anion such as a carborate anion, or alkoxymetalate and aryloxymetalate ion.

Examples of anions X⁻ are tetrachlorometalates [MCl₄]⁻ where M=Al, Ga, tetrafluoroborates [BF₄]⁻, hexafluorometalates [MF₆]⁻ where M=As, Sb, Ir, Pt, perfluoroantimonates [Sb₂F₁₁]⁻, [Sb₃F₁₆]⁻ and [Sb₄F₂₁]⁻, triflate (=trifiuoromethanesulfonate) [OSO₂CF₃]⁻, tetrakis(trifluoromethyl)borate [B(CF₃)₄]⁻, tetrakis(pentafluorophenyl)metalates [M(C₆F₅)₄]⁻ where M=B, Al, Ga, tetrakis(pentachlorophenyl)borate [B(C₆Cl₅)₄]⁻, tetrakis[2,4,6-(trifluoromethyl)phenyl]borate {B[C₆H₂(CF₃)₃]}⁻, hydroxybis[tris(pentafluorophenyl)borate] {HO[B(C₆F₃)₃]₂}⁻, closo-carborates [CHB₁₁H₅Cl₆]⁻, [CHB₁₁H₅Br₆]⁻, [CHB₁₁ (CH₃)₅Br₆]⁻, [CHB₁₁F₁₁]⁻, [C(Et)B₁₁F₁₁]⁻, [CB₁₁(CF₃)₁₂]⁻ and B₁₂Cl₁₁N(CH₃)₃]⁻, tetra(perfluoroalkoxy)aluminate [Al(OR^{PF})₄]⁻, tris(perfluoroalkoxy)fluoroaluminate [FAl(OR^{PF})₃]⁻, hexakis(oxypentafluorotelluro)antimonate [Sb(OTeF₅)₆]⁻.

An overview of particularly preferred complex anions X⁻ may be found in, for example, Krossing et. al., Angew. Chem. 2004, 116, 2116.

The preparation of the cationic Si(II) compound of the general formula IV can be carried out by addition of an acid H⁺X⁻ to the compound Si(II)Cp₂, by means of which one of the anionic Cp radicals is eliminated in protonized form:

Si(II)Cp₂+H⁺X⁻->Si(II)⁺CpX⁻+CpH

The anion X⁻ of the acid HX then forms the counterion of the cationic silicon(II) compound.

One preparative method for the cationic Si(II) compound of the general formula II is described in Science 2004, 305, pp. 849-851:

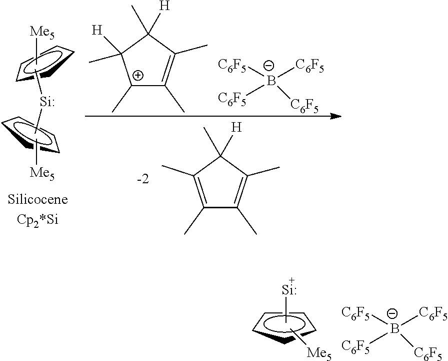

The formation of the cationic Si(II) compound of the general formula IV is effected there by means of the acid (Cp*H₂)⁺ B(C₆F₅)₄⁻ (Cp*=pentamethylcyclopentadienyl). This gives the compound of the formula IV with the counterion X⁻=B(C₆F₅)₄⁻, which is very readily crystallizable and can therefore be isolated particularly easily. However, the compound of the general formula IV can also be produced by addition of other Bronsted acids, with preference being given to acids whose anions meet the abovementioned requirements of weak coordination.

The compound D having at least one alkoxy group bound direct to silicon preferably has the general formula VI

R¹³R¹⁴R¹⁵Si—O—CH₂—R¹⁶ (VI)

where the radicals R¹³, R¹⁴ and R¹⁵ are each, independently of one another, hydrogen, halogen, a silyloxy radical, preferably of the above general formula II, or a hydrocarbon radical, in which individual carbon atoms can in each case be replaced by oxygen atoms, halogen, sulfur or phosphorus atoms, and R¹⁶ is hydrogen or a hydrocarbon radical in which individual nonadjacent carbon atoms can be replaced by oxygen atoms, silicon, halogen, sulfur or phosphorus atoms.

The radicals R¹³, R¹⁴ and R¹⁵ are each, independently of one another, particularly preferably hydrogen, halogen, an unbranched, branched, linear, acyclic or cyclic, saturated or monounsaturated or polyunsaturated C1-C20-hydrocarbon radical or an unbranched, branched, linear or cyclic, saturated or monounsaturated or polyunsaturated C1-C20-hydrocarbonoxy radical, in which individual carbon atoms can be replaced by oxygen, halogen or sulfur, or a silyloxy radical of the general formula II, where

R^{x} has the above meanings and preferred meanings.

R¹⁶ is particularly preferably hydrogen, an unbranched, branched, linear, acyclic or cyclic, saturated or monounsaturated or polyunsaturated C1-C20-hydrocarbon radical or an unbranched, branched, linear or cyclic, saturated, or monounsaturated or polyunsaturated C1-C20-hydrocarbonoxy radical, in which individual carbon atoms can be replaced by oxygen, halogen or sulfur, or a silyloxy radical of the general formula where

R^{x} has the above meanings and preferred meanings.

a, b, c and d are, independently of one another, integers from 0 to 100 000, where the sum of a, b, c and d together is at least 1.

The silyloxy radical of the general formula II preferably has a molecular weight of less than 10 000, particularly preferably less than 5000 and very particularly preferably less than 1000 dalton.

The radicals R¹³, R¹⁴ and R¹⁵ are each, independently of one another, very particularly preferably hydrogen, chlorine, a C1-C3-alkyl or alkylene radical, a phenyl radical or a silyloxy radical of the general formula II, in which the radicals R are each, independently of one another, hydrogen, chlorine, C1-C6-alkyl or alkylene or phenyl.

R¹⁶ is very particularly preferably hydrogen, a C1-C6-alkyl or alkylene radical or phenyl radical.

Particularly preferred radicals R¹³, R¹⁴ and R¹⁵ are the radicals methyl, ethyl, propyl, phenyl, chlorine or a silyloxy radical, in particular of the general formula II.

Particularly preferred radicals R¹⁶ are the radicals methyl, ethyl, propyl, butyl or pentyl.

Particularly preferred radicals R^{x} are the radicals methyl, ethyl, propyl, phenyl and chlorine.

Examples of compounds D of the general formula. VI are the following silanes (Ph=phenyl, Me=methyl, Pt=ethyl):

Me₃SiOEt, Me₃SiOMe, Et₃SiOEt, Et₃SiOMe, Me₂PhSiOEt, Me₂PhSiOMe, MePh₂SiOEt, Me₃SiO—CH₂—CH₂—OSiMe₃, Me₃SiO—(CH₂)₃—OSiMe₃, Me₂Si(OEt)₂, Me₂Si(OMe)₂, MeSi(OEt)₃, MeSi(OMe)₃, Si(OEt)₄, MeSi(OMe)₄, and the following siloxanes:
Me₃Si—O—SiMe₂OMe, Me₃Si—O—SiMe₂OEt, EtOSiMe₂-O—SiMe₂OEt, Me₃Si—O—SiMe(OMe)-O—SiMe₃, Me₃Si—O—SiMe(OEt)-O—SiMe₃,
MeO—SiMe₂-(O—SiMe₂)ₙ—O—SiMe₂-OMe and EtO—SiMe₂-(O—SiMe₂)ₙ—O—SiMe₂-OEt where m=1 to 10,
Me₃Si—O—(SiMe₂-O)ₙ(SiMe(OMe)-O)ₒ—SiMe₃ and Me₃Si—O—(SiMe₂-O)ₙ(SiMe(OEt)-O)ₒ—SiMe₃ where n=0 to 10 and o=1 to 10.

The compound D can also be a mixture of various compounds of the general formulae VI, in which the radicals R¹³, R¹⁴ and R¹⁵ can optionally be various radicals of the general formula II.

The invention likewise provides a method for hydrosilylating the mixture M containing

compound A which contains at least one hydrogen atom bound directly to Si,
compound B which contains at least one carbon-carbon multiple bond,
compound C which contains at least one cationic Si(II) group and
compound D which contains at least one alkoxy group bound directly to silicon,
wherein the mixture M is heated.

In the method, compound A is reacted with compound B in the presence of compound C as hydrosilylation catalyst. The hydrosilylation reaction which is catalyzed by compound C as nonmetallic hydrosilylation catalyst and suppressed by inhibitor D is triggered by an increase in temperature.

In the method, the mixture. M is preferably heated to at least 40° C. and not more than 150° C., particularly preferably to from 50 to 120° C., in particular to from 60 to 100° C.

The molar ratio of the compounds A and B is, based on the Si—H or unsaturated carbon groups present, preferably at least 1:100 and not more than 100:1, particularly preferably at least 1:10 and not more than 10:1, very particularly preferably at least 1:2 and not more than 2:1.

The molar ratio between the compound C and the Si—H groups present in the compound A is preferably at least 1:10⁷ and not more than 1:1, particularly preferably at least 1:10 and not more than 1:10, very particularly preferably at least 1:10⁵ and not more than 1:50.

The molar ratio of the compounds C and D is, based on the cationic Si(II) group present in the compound C to the alkoxy group bound directly to silicon in the compound D, preferably at least 1:1 and not more than 1:200, particularly preferably at least 1:5 and not more than 1:100, very particularly preferably at least 1:10 and not more than 1:50.

The compounds A, B, C and D can be mixed at low temperature, in particular below 30° C., in particular below 20° C., in any order, with mixing being carried out in a manner known in the art. Preference is given to embodiments in which a mixture of C and D is mixed with A or with B or the mixture of A and B. In a further preferred embodiment, D is mixed with A or with B or with the mixture of A and B and the mixture is subsequently admixed with C.

In a further embodiment, the compound C is produced in the mixture of the two compounds, for example, by the above-described protonation reaction in one of the compounds A or B or D or in binary mixtures of A, B and D or in the ternary mixture of A, B and D.

The reaction of the compounds A and B in the presence of the compounds C and D can be carried out with or without addition of one or more solvents. The proportion of the solvent or the solvent mixture is, based on the sum of the compounds A and B, preferably at least 0.1% by weight and not more than a 1000-fold amount by weight, particularly preferably at least 10% by weight and not more than a 100-fold amount by weight, very particularly preferably at least 30% by weight and not more than the 10-fold amount by weight.

As solvents, preference is given to using aprotic solvents, for example hydrocarbons such as pentane, hexane, heptane, cyclohexane or toluene, chlorinated hydrocarbons such as dichloromethane, chloroform, chlorobenzene or 1,2-dichloroethane, or nitriles such as acetonitrile or propionitrile.

The mixture M can contain any further compounds such as processing aids, e.g. emulsifiers, fillers, e.g. finely divided silica or quartz, stabilizers, e.g. free-radical inhibitors, pigments, e.g. dyes or white pigments, e.g. chalk or titanium dioxide.

The reaction can be carried out under ambient pressure or under reduced pressure or under superatmospheric pressure.

The pressure is preferably at least 0.01 bar and not more than 100 bar, particularly preferably at least 0.1 bar and not more than 10 bar, and the reaction is very particularly preferably carried out at ambient pressure. However, if compounds which are gaseous at the reaction temperature participate in the reaction, a reaction is preferably carried out under superatmospheric pressure, particularly preferably at the vapor pressure of the overall system.

All symbols shown above in the above formulae have, in each case, their meanings independently of one another. In all formulae, the silicon atom is tetravalent.

Unless indicated otherwise in the particular case, all amounts and percentages are by weight, and all temperatures are 20° C.

### EXAMPLE 1

A mixture of 239 mg (2.02 mmol) of α-methylstyrene and 300 mg (2.02 mmol) of pentamethyldisiloxane is admixed under an inert gas atmosphere (argon) with a solution of 1.8 mg (2.14 μmol) of the compound (π-Me₅C₅)Si⁺ B(C₆F₅)₄⁻ and 4.8 mg (0.041 mmol) of ethoxytrimethylsilane in 540 mg of dideuterodichloromethane with shaking and allowed to stand at 25° C. for 8 days. The reaction mixture is examined by NMR spectroscopy after this time: α-methylstyrene and pentamethyldisiloxane are present in an unchanged amount, and no hydrosilylation product can be detected. The catalyst (π-Me₅C₅)Si⁺ B(C₆F₅)₄⁻ is detectable in an unchanged amount by NMR spectroscopy (singlet at δ=2.2 ppm). The sample is subsequently heated at 60° C. for 1 hour and then examined again by NMR spectroscopy: formation of the hydrosilylation product, 1,1,1,3,3-pentamethyl-3-(2-phenylpropyl)disiloxane, conversion >99%.

### EXAMPLE 2

A mixture of 239 mg (2.02 mmol) of α-methylstyrene and 300 mg (2.02 mmol) of pentamethyldisiloxane is admixed under an inert gas atmosphere (argon) with a solution of 1.7 mg (2.02 μmol) of the compound (π-Me₅C₅)Si⁺ B(C₆F₅)₄⁻ and 7.8 mg (0.041 mmol) of ethoxypentamethyldisiloxane in 860 mg of dideuterodichloromethane with shaking and allowed to stand at 25° C. for 9 days. The reaction mixture is examined by NMR spectroscopy after this time: α-methylstyrene and pentamethyldisiloxane are present in an unchanged amount, and no hydrosilylation product can be detected. The catalyst (π-Me₅C₅)Si⁺ B(C₆F₅)₄⁻ is detectable in an unchanged amount by NMR spectroscopy (singlet at δ=2.2 ppm).

The sample is subsequently heated at 60° C. for 1 hour and then examined again by NMR spectroscopy: formation of the hydrosilylation product, 1,1,1,3,3-pentamethyl-3-(2-phenylpropyl)disiloxane, conversion >99%.

### EXAMPLE 3

A mixture of 239 mg (2.02 mmol) of α-methylstyrene and 300 mg (2.02 mmol) of pentamethyldisiloxane is admixed under an inert gas atmosphere (argon) with a solution of 1.9 mg (2.26 μmol) of the compound (π-Me₅C₅)Si⁺ B(C₆F₅)₄⁻ and 7.5 mg (0.042 mmol) of dimethylphenylethoxysilane in 741 mg of dideuterodichloromethane with shaking and allowed to stand at 25° C. for 8 days. The reaction mixture is examined by NMR spectroscopy after this time: α-methylstyrene and pentamethyldisiloxane are present in an unchanged amount, and no hydrosilylation product can be detected. The catalyst (π-Me₅C₅)Si⁺ B(C₆F₅)₄⁻ is detectable in an unchanged amount by NMR spectroscopy (singlet at δ=2.2 ppm).

The sample is subsequently heated at 60° C. for 1 hour and then examined again by NMR spectroscopy: formation of the hydrosilylation product, 1,1,1,3,3-pentamethyl-3-(2-phenylpropyl)disiloxane, conversion >99%.

### EXAMPLE 4, NOT ACCORDING TO THE INVENTION

Analogous to example 1 using B(C₆F₅)₃ instead of (π-Me₅C₅)Si⁺ B(C₆F₅)₄⁻.

Hydrosilylation with Addition of Inhibitor

A mixture of 289 mg (2.02 mmol) of α-methylstyrene and 300 mg (2.02 mmol) of pentamethyldisiloxane is admixed under an inert gas atmosphere (argon) with a solution of 1.8 mg (2.14 μmol) of the compound (π-Me₅C₅)Si⁺ B(C₆F₅)₄⁻ in 540 mg of dideuterodichloromethane with shaking and allowed to stand at 25° C. for 20 minutes and after this time is examined by NMR spectroscopy. The hydrosilylation to form the hydrosilylation product has proceeded to completion.

1. A mixture M containing;
compound A which contains al least one hydrogen atom bound directly to Si;
compound B which contains at least one carbon-carbon multiple bond;
compound C which contains at least one cationic Si(II) group; and
compound D which contains at least one alkoxy group bound directly to silicon,
wherein the molar ratio of the compounds A and B, based on Si—H groups present and unsaturated carbon groups, is at least 1:100 and not more than 100:1,
wherein the molar ratio between the compound C and the Si—H groups present in the compound A is at least 1:10⁷ and not more than 1:1, and
wherein the molar ratio of the compounds C and D, based on the cationic Si(II) groups present in the compound C, to the alkoxy groups bound directly to silicon in the compound D is at least 1:1 and not more than 1:200.

2. A method for hydrosilylating a mixture M of claim 1, wherein the mixture M is heated to at least 40° C. and not more than 150° C.

3. The mixture M of claim 1, wherein the compound A has the general formula I
R¹R²R³Si—H (1),
where the radicals R¹, R² and R³ are each, independently of one another, hydrogen, halogen, a silyloxy radical or a hydrocarbon radical, in which individual carbon atoms can in each case be replaced by oxygen atoms, silicon atoms, nitrogen atoms, halogen, sulfur or phosphorus atoms.

4. The mixture M of claim 3, wherein the compound B is selected from among compounds of the general formula IIIa
R⁴R⁵C═CR⁶R⁷ (IIIa),
and compounds of the genera formula IIIb
R⁸CCR⁹ (IIIb),
where R⁴, R⁵, R⁶, R⁷, R⁸ and R⁹ are each, independently of one another, a linear, branched, acyclic or cyclic, saturated or monounsaturated or polyunsaturated C1-C20-hydrocarbon radical, in which individual carbon atoms can be replaced by silicon, oxygen, halogen, nitrogen, sulfur or phosphorus.

5. The mixture M of claim 4, wherein the compound C is a cationic Si(II) compound of the general formula IV
([Si(II)Cp]⁺)ₙX^{a-} (IV)
where Cp is a π-bonded cyclopentadienyl radical of the general formula V, which is substituted by the radicals R^{y}, 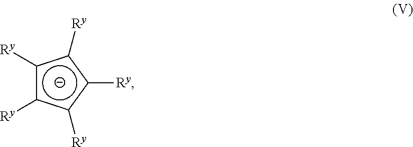
the radicals
R^{y} are monovalent radicals or polyvalent radicals which can also be joined to one another to form fused rings, and
X⁻ is an a-valent anion which does not react with the cationic silicon(II) center under the reaction conditions of a hydrosilylation.

6. The mixture M of claim 4, wherein the compound C is selected from among the cationic Si(II) compounds: 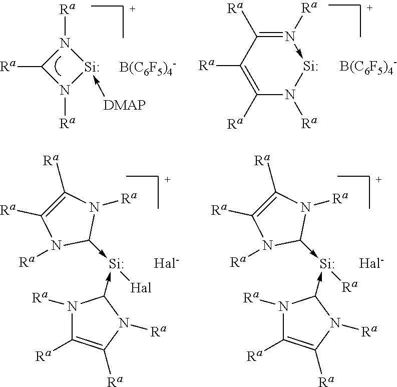
where the radicals R^{a} are, independently of one another, hydrocarbon radicals and Hal is halogen.

7. The mixture M of claim 5, wherein compound D has the general formula VI
R¹³R¹⁴R¹⁵Si—O—CH₂—R¹⁶ (VI)
where the radicals R¹³, R¹⁴ and R¹⁵ are each, independently of one another, hydrogen, halogen, a silyloxy radical, or a hydrocarbon radical, in which individual carbon atoms can in each case be replaced by oxygen atoms, halogen, sulfur or phosphorus atoms, and
R¹⁶ is hydrogen or a hydrocarbon radical in which individual nonadjacent carbon atoms can be replaced by oxygen atoms, silicon, halogen, sulfur or phosphorus atoms.

8. (canceled)

9. (canceled)

10. The mixture M of claim 6, wherein compound D has the general formula VI
R¹³R¹⁴R¹⁵Si—O—CH₂—R¹⁶ (VI)
where the radicals R¹³, R¹⁴ and R¹⁵ are each, independently of one another, hydrogen, halogen, a silyloxy radical, or a hydrocarbon radical, in which individual carbon atoms can in each case be replaced by oxygen atoms, halogen, sulfur or phosphorus atoms, and
R¹⁶ is hydrogen or a hydrocarbon radical in which individual nonadjacent carbon atoms can be replaced by oxygen atoms, silicon, halogen, sulfur or phosphorus atoms.
